(19) United States
(12) Patent Application Publication
(10) Pub. No.: US 2019/0117004 A1
(43) Pub. Date: Apr. 25, 2019

(54) Cooking Pan Assembly

(71) Applicant: Karla Baus, Pierre, SD (US)

(72) Inventor: Karla Baus, Pierre, SD (US)

(21) Appl. No.: 15/789,627

(22) Filed: Oct. 20, 2017

(51) Int. Cl. A47J 27/00; A47J 36/00

(52) U.S. Cl. CPC A47J 27/002; A47J 36/00

(57) ABSTRACT

A cooking pan assembly includes a pan that may have food items positioned therein. The pan has a bottom end and the bottom end is open to pass grease therethrough when the food items are cooked. A grill is provided and the grill is selectively positioned in a cooking device. The pan is removably coupled to the grill such that the grill passes the grease therethrough. A plurality of couplers is provided and each of the couplers is coupled to the grill. Each of the couplers releasably engages the pan to retain the pan on the grill. A spacing unit is removably positioned in the pan. The spacing unit is structured to have a plurality of compartments and each of the compartments receives one of the food items thereby retaining the food items in an upright position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to cooking devices and more particularly pertains to a new cooking device for retaining food items in an upright position for cooking.

### BRIEF SUMMARY OF THE INVENTION

An embodiment of the disclosure meets the needs presented above by generally comprising a pan that may have food items positioned therein. The pan has a bottom end and the bottom end is open to pass grease therethrough when the food items are cooked. A grill is provided and the grill is selectively positioned in a cooking device. The pan is removably coupled to the grill such that the grill passes the grease therethrough. A plurality of couplers is provided and each of the couplers is coupled to the grill. Each of the couplers releasably engages the pan to retain the pan on the grill. A spacing unit is removably positioned in the pan. The spacing unit is structured to have a plurality of compartments and each of the compartments receives one of the food items thereby retaining the food items in an upright position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a cooking pan assembly according to an embodiment of the disclosure.

FIG. 2 is a right side view of an embodiment of the disclosure.

FIG. 3 is a front view of an embodiment of the disclosure.

FIG. 4 is an exploded perspective view of an embodiment of the disclosure.

FIG. 5 is a cross sectional view taken along line 5-5 of FIG. 4 of an embodiment of the disclosure.

FIG. 6 is a cross sectional view taken along line 6-6 of FIG. 4 of an embodiment of the disclosure.

### DETAILED DESCRIPTION OF THE INVENTION

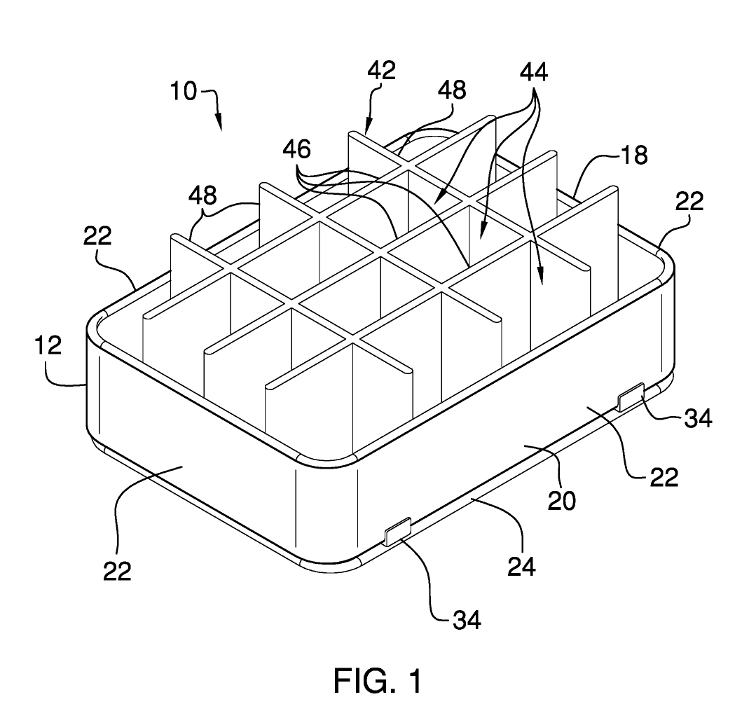

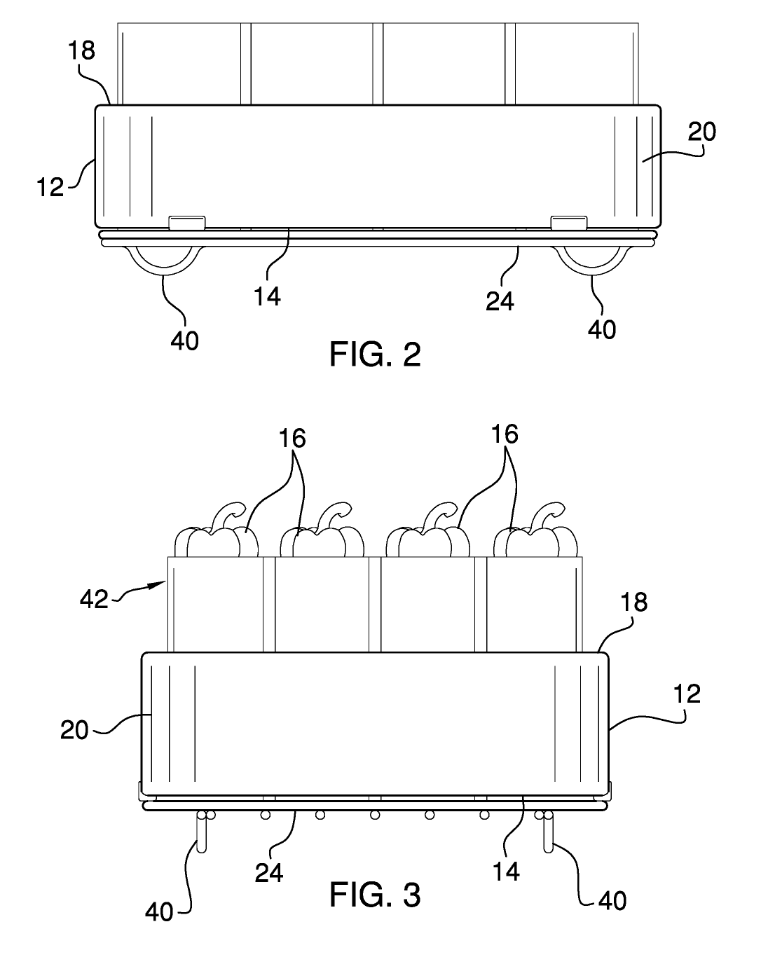

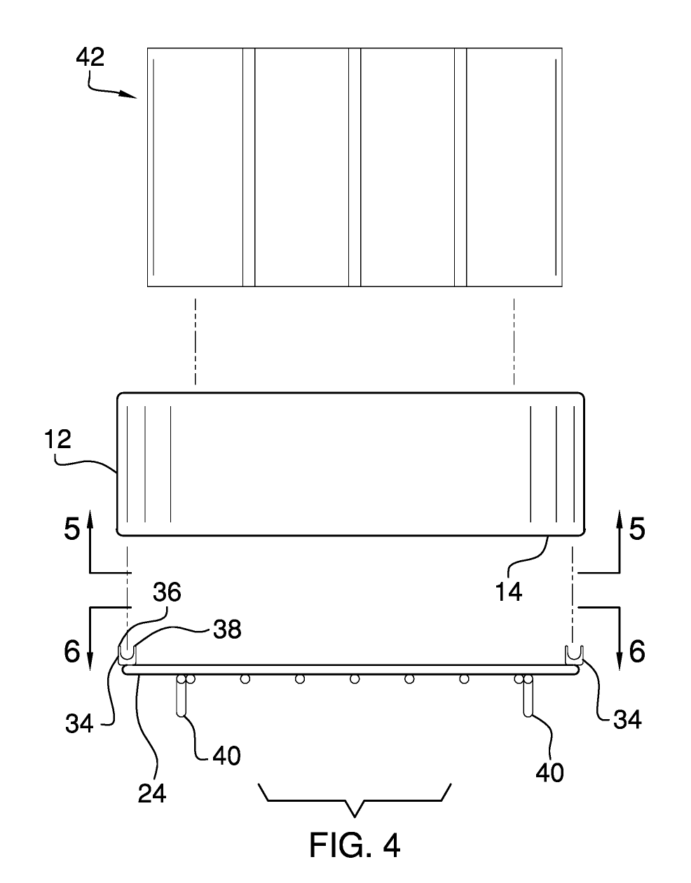

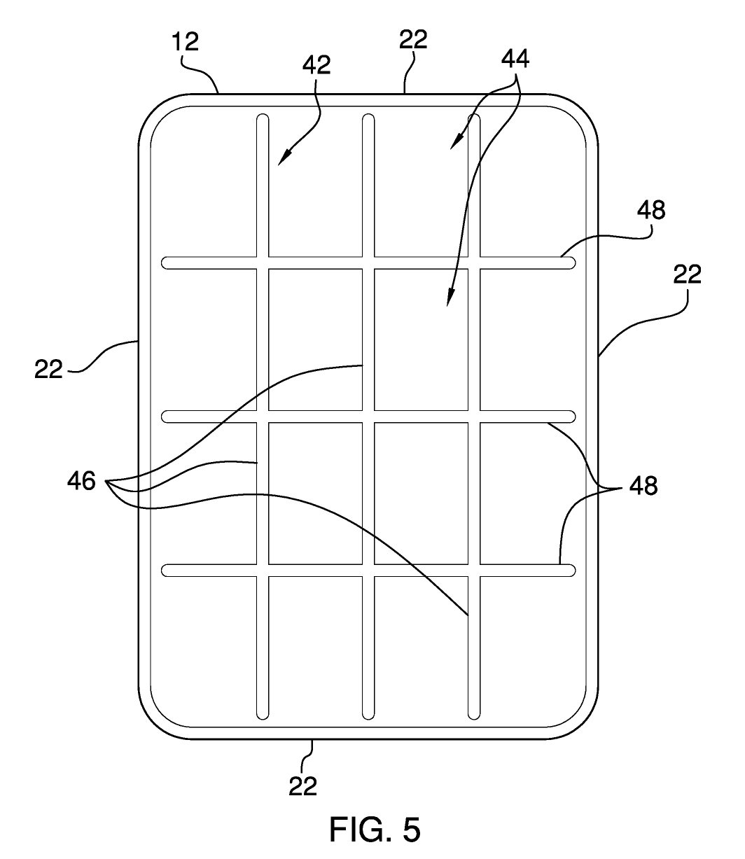

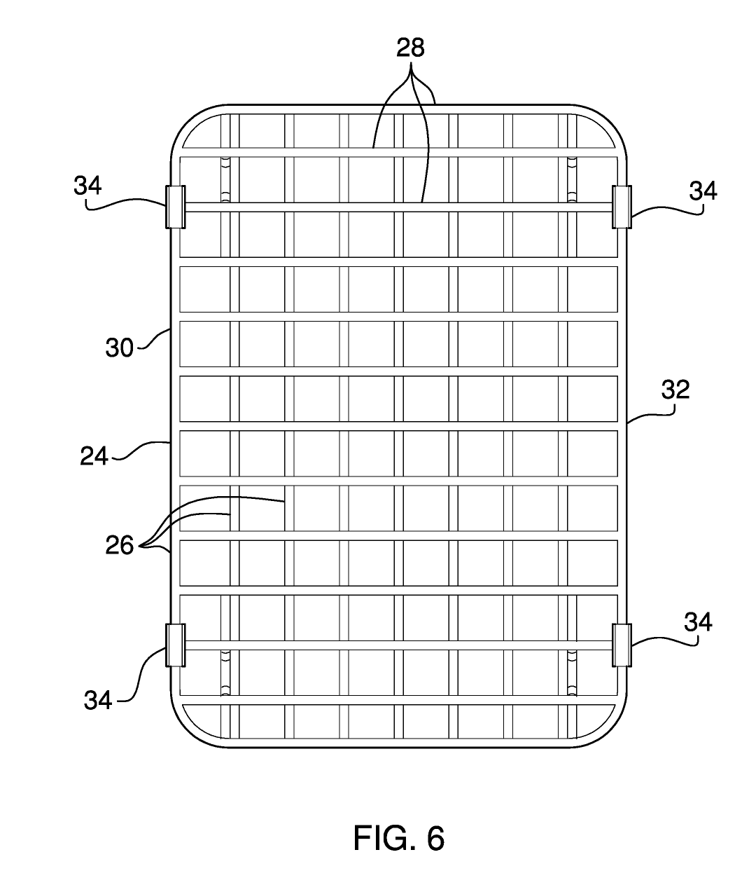

With reference now to the drawings, and in particular to FIGS. 1 through 6 thereof, a new cooking device embodying the principles and concepts of an embodiment of the disclosure and generally designated by the reference numeral 10 will be described.

As best illustrated in FIGS. 1 through 6, the cooking pan assembly 10 generally comprises a pan 12 that may have food items 16 positioned therein. The pan 12 has a bottom end 14 and the bottom end 14 is open. Thus, the bottom end 14 passes grease therethrough when the food items 16 are cooked. The food items 16 may be jalapeno poppers, stuffed mushrooms, stuffed peppers, bacon and any other food item that produces grease when cooked.

The pan 12 has a top end 18 and an outer wall 20 extending between the top end 18 and the bottom end 14. The top end 18 is open and the outer wall 20 has a plurality of intersecting sides 22. Thus, the pan 12 has a rectangular cross-section taken along a line extending through the top end 18 and the bottom end 14. Moreover, the pan 12 may be comprised of a rigid and thermally conductive material such as steel or the like.

A grill 24 is provided and the grill 24 is selectively positioned in a cooking device, such as an oven, a gas grill 24 and any other cooking device. The pan 12 is removably coupled to the grill 24 such that the grill 24 passes the grease therethrough. The grill 24 has a plurality of first members 26 and a plurality of second members 28. Each of the first members 26 intersects and is oriented perpendicular to the second members 28. Additionally, the plurality of first members 26 includes a first outermost member 30 and a second outermost member 32.

A plurality of couplers 34 is provided and each of the couplers 34 is coupled to the grill 24. Each of the couplers 34 releasably engages the pan 12 to retain the pan 12 on the grill 24. Each of the couplers 34 has a first end 36 and a second end 38. Moreover, each of the couplers 34 is concavely arcuate between the first end 36 and the second end 38 such that each of the couplers 34 forms a saddle. Each of the couplers 34 is coupled to and extends upwardly from an associated one of the first outermost member 30 and the second outermost member 32. Additionally each of the couplers 34 insertably receives the bottom end 14 of the pan 12.

A plurality of feet 40 is provided and each of the feet 40 is coupled to the grill 24. Each of the feet 40 abuts the cooking device when the grill 24 is positioned in the cooking device. Additionally, each of the feet 40 extends downwardly from the grill 24. The feet 40 are spaced apart from each other and are distributed around the grill 24. Each of the feet 40 may comprise an inverted, open loop, a peg and any other type of foot.

A spacing unit 42 is provided and the spacing unit 42 is selectively and removably positioned in the pan 12. The spacing unit 42 is structured to have a plurality of compartments 44. Each of the compartments 44 receives one of the food items 16. Additionally, the spacing unit 42 retains the food items 16 in an upright position for cooking. The pan 12 may be employed without the spacing unit 42 for cooking a cake or the like.

The spacing unit 42 includes a plurality of first panels 46 and a plurality of second panels 48. Each of the first panels 46 intersects each of the second panels 48. Each of the first panels 46 is spaced apart from each other and each of the second panels 48 is spaced apart from each other. In this way each of the first panels 46 and the second panels 48 defines the plurality of compartments 44. Each of the first panels 46 and the second panels 48 is vertically oriented when the spacing unit 42 is positioned in the pan 12 such that each of the compartments 44 is vertically oriented.

In use, the bottom end 14 of the pan 12 is positioned in each of the couplers 34 to retain the grill 24 on the pan 12. Thus, the grill 24 facilitates grease to pass out of the pan 12 when the food items 16 are cooked. The spacing unit 42 is selectively positioned in the pan 12 and each of the food items 16 is positioned in an associated one of the compartments 44. Thus, the spacing unit 42 retains each of the food items 16 in an upright position having each of the food items 16 being spaced apart from each other.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cooking pan assembly being configured to retain a plurality of food items in an upright position thereby facilitating the food items to be cooked, said assembly comprising:
a pan being configured to have food items positioned therein, said pan having a bottom end, said bottom end being open wherein said bottom end is configured to pass grease therethrough when the food items are cooked;
a grill being configured to be positioned in a cooking device, said pan being removably coupled to said grill wherein said grill is configured to pass the grease therethrough;
a plurality of couplers, each of said couplers being coupled to said grill, each of said couplers releasably engaging said pan to retain said pan on said grill; and
a spacing unit being removably positioned in said pan, said spacing unit being structured to have a plurality of compartments wherein each of said compartments is configured to receive one of the food items thereby retaining the food items in an upright position.

2. The assembly according to claim 1, wherein said pan having a top end and an outer wall extending between said top end and said bottom and, said top end being open, said outer wall having a plurality of intersecting sides such that said pan has a rectangular cross-section taken along a line extending through said top end and said bottom end.

3. The assembly according to claim 2, wherein said grill has a plurality of first members and a plurality of second members, each of said first members intersecting and being oriented perpendicular to said second members, said plurality of first members including a first outermost member and a second outermost member.

4. The assembly according to claim 3, wherein each of said couplers has a first end and a second end, each of said couplers being concavely arcuate between said first end and said second end such that each of said couplers forms a saddle, each of said couplers being coupled to and extending upwardly from an associated one of said first outermost member and said second outermost member, each of said couplers insertably receiving said bottom edge of said pan.

5. The assembly according to claim 3, further comprising a plurality of feet, each of said feet being coupled to said grill wherein each of said feet is configured to abut the cooking device, each of said feet extending downwardly from said grill.

6. The assembly according to claim 1, wherein said spacing unit includes a plurality of first panels and a plurality of second panels, each of said first panels intersecting each of said second panels.

7. The assembly according to claim 6, wherein each of said first panels is spaced apart from each other, each of said second panels being spaced apart from each other such that each of said first panels and said second panels defines said plurality of compartments.

8. The assembly according to claim 7, wherein each of said first panels and said second panels is vertically oriented when said spacing unit is positioned in said pan such that each of said compartments is vertically oriented.

9. A cooking pan assembly being configured to retain a plurality of food items in an upright position thereby facilitating the food items to be cooked, said assembly comprising:
a pan being configured to have food items positioned therein, said pan having a bottom end, said bottom end being open wherein said bottom end is configured to pass grease therethrough when the food items are cooked, said pan having a top end and an outer wall extending between said top end and said bottom and, said top end being open, said outer wall having a plurality of intersecting sides such that said pan has a rectangular cross-section taken along a line extending through said top end and said bottom end;
a grill being configured to be positioned in a cooking device, said pan being removably coupled to said grill wherein said grill is configured to pass the grease therethrough, said grill having a plurality of first members and a plurality of second members, each of said first members intersecting and being oriented perpendicular to said second members, said plurality of first members including a first outermost member and a second outermost member;
a plurality of couplers, each of said couplers being coupled to said grill, each of said couplers releasably engaging said pan to retain said pan on said grill, each of said couplers having a first end and a second end, each of said couplers being concavely arcuate between said first end and said second end such that each of said couplers forms a saddle, each of said couplers being coupled to and extending upwardly from an associated one of said first outermost member and said second outermost member, each of said couplers insertably receiving said bottom edge of said pan;
a plurality of feet, each of said feet being coupled to said grill wherein each of said feet is configured to abut the cooking device, each of said feet extending downwardly from said grill; and
a spacing unit being removably positioned in said pan, said spacing unit being structured to have a plurality of compartments wherein each of said compartments is configured to receive one of the food items thereby retaining the food items in an upright position, said spacing unit including a plurality of first panels and a plurality of second panels, each of said first panels intersecting each of said second panels, each of said first panels being spaced apart from each other, each of said second panels being spaced apart from each other such that each of said first panels and said second panels defines said plurality of compartments, each of said first panels and said second panels being vertically oriented when said spacing unit is positioned in said pan such that each of said compartments is vertically oriented.
